(19) United States
(12) Patent Application Publication
(10) Pub. No.: US 2026/0235351 A1
(43) Pub. Date: Aug. 13, 2026

(54) APPARATUS AND PROCESS FOR UTILIZATION OF HYDROGEN GAS OUTPUT FROM A TRAILER

(71) Applicant: AIR PRODUCTS AND CHEMICALS, INC., Allentown, PA (US)

(72) Inventors: Pratik Misra, Breinigsville, PA (US); Gowri Krishnamurthy, Sellersville, PA (US); Lucas A. White, Chandler, AZ (US); John H. Petrik, Bethlehem, PA (US); Aun Kang Leong, Surrey (GB)

(73) Assignee: AIR PRODUCTS AND CHEMICALS, INC., (US)

(21) Appl. No.: 19/156,550

(22) PCT Filed: Feb. 15, 2024
(86) PCT No.: PCT/US2024/015897

§ 371 Date: Aug. 14, 2025

Related U.S. Application Data
(60) Provisional application No. 63/446,909, filed on Feb. 20, 2023.

(51) Int. Cl. F25J 1/00; F25J 1/02

(52) U.S. Cl. CPC F25J 1/004; F25J 1/001; F25J 1/023; F25J 2230/30; F25J 2290/62

(57) ABSTRACT

A process for utilization of hydrogen gas output from at least one trailer can include forming hydrogen gas from liquid hydrogen stored within at least one trailer and feeding the hydrogen gas from the trailer(s) to a pipeline, a turbine, a liquefaction unit for subsequent liquefaction of the hydrogen gas, a fuel cell, and/or a compression system for compression of the hydrogen gas for subsequent liquefaction of compressed hydrogen gas output from the compression system via a liquefaction unit connected to the compression system. Apparatuses for utilization of hydrogen gas output from at least one trailer can be configured to implement an embodiment of the process.

### CROSS-REFERENCE TO RELATED APPLICATIONS

This application claims priority to U.S. Provisional Patent Application No. 63/446,909, which was filed on Feb. 20, 2023.

### FIELD

The present innovation relates to processes and systems for utilization of hydrogen gas output from at least one trailer configured to store liquefied hydrogen. Hydrogen may also be referred to herein as H2 or H₂.

### BACKGROUND

Hydrogen can be formed produced from fossil fuels. Examples of hydrogen production systems can be appreciated from U.S. Patent Application Publication Nos. 2022/0397119, 2022/0397118, 2022/0033983 and U.S. Pat. Nos. 3,375,076 and 7,275,569. Transportation of hydrogen can be provided via transportable hydrogen storage vessels. Examples of vessels for storing cryogenic liquids and transportation systems used for hydrogen transport can be appreciated from European Patent No. 3 249 282B1 , U.S. Pat. Nos. 10,508,770 and 7,581,405, and U.S. Patent Application Publication Nos. 2015/006822 and 2011/0169269.

### SUMMARY

We determined that conventional hydrogen production systems that feed liquified hydrogen into a tank for storage will often include a conduit arrangement for venting of gaseous hydrogen to the atmosphere. This venting is often provided to avoid an over pressurization condition that may occur due to hydrogen gas vaporizing over time as it is stored in a vessel, for example. Conventionally, the excess vapor is vented to atmosphere to avoid this condition and ensure the vessel avoids leaking or experiences another type of problem that can be caused from over pressurization. In smaller scale systems, the amount of hydrogen that is ultimately vented is typically a small amount, and venting the hydrogen is usually considered to be a proficient approach for addressing hydrogen vaporization that can occur while liquid hydrogen is within a storage vessel.

We determined that in hydrogen production systems that are designed to produce substantial amounts of hydrogen for transporting compressed hydrogen gas to off-site locations via transportation vehicles (e.g., trailers moved via truck, tube trailers transported via roadway vehicle such as a truck, rail vehicle such as a train, and/or water vehicle such as a ship, etc.), venting of hydrogen can result in a loss of hydrogen. We determined that this can be an even larger problem when liquid hydrogen is to be transported because the liquid hydrogen can often vaporize during filling and/or transport to an extent that venting may be needed to avoid over pressurization or other problems. Such venting can result in a loss of hydrogen.

We determined that this can be true for “green hydrogen” systems that are designed to form hydrogen via renewable power sources and non-carbon-based feeds (e.g., water, ammonia, etc.). We determined that this can also be the case in so called “blue hydrogen” systems that may utilize carbon capture technologies to reduce the carbon footprint associated with hydrogen production from more conventional sources (e.g., so called “grey hydrogen” sources). In some implementations, a green hydrogen or blue hydrogen production facility can be configured to form between 2-10 times as much liquid hydrogen as a conventional system for distribution to transportation vessels for transport to off-site locations. In yet other implementations, it is contemplated that the amount of liquified hydrogen fed to transportation vessels can be even higher.

We believe we have recognized an unexpected problem that can result from such systems because the conventional approach of venting vaporized hydrogen in such systems can create significant hydrogen losses at larger scale. However, we determined that venting of hydrogen to the atmosphere as done conventionally can be a significant problem. We believe this is especially the case for large green hydrogen or blue hydrogen liquefaction systems that may be designed to supply transport vessels with liquid hydrogen for subsequent transport to various off-site hydrogen fueling stations and/or liquified hydrogen storage vessels retaining hydrogen therein as a fuel for powering industrial operations. The scale such systems can have was surprisingly found to cause a significant problem in hydrogen losses that can be caused from hydrogen vapor (or hydrogen gas) venting from storage vessels (e.g., trailers) to be filled with liquid hydrogen for subsequent transport to other locations (e.g., off-site locations, fueling stations, off-site liquid hydrogen storage vessels, etc.).

In addition to economic reasons, minimizing losses can help maximize the energy efficiency of green and blue hydrogen production creating a more sustainable solution. Also, we determined that avoiding or minimizing any venting of hydrogen can provide environmental impact improvements because venting of hydrogen may have environmental implications (e.g., hydrogen gas may be considered an indirect greenhouse gas).

We have developed embodiments of apparatuses and processes for hydrogen vapor utilization that can permit venting of hydrogen to be avoided (e.g., completely eliminated, or at least substantially eliminated where such venting may only occur in a rare situation involving a safety condition resulting from unexpected and extreme over pressuring of a vessel, etc.). In contrast to a conventional approach, embodiments of our process and apparatus can be configured so that the hydrogen gas formed in one or more trailers being filled with liquid hydrogen or storing liquid hydrogen can be output from the trailer(s) and provided to a compression system and/or liquefaction unit for undergoing liquefaction so that the hydrogen is not lost to the atmosphere. In addition, or as an alternative, the hydrogen gas output from the trailer(s) can be fed to a turbine (e.g., a hydrogen turbine) for power generation or can be fed to a pipeline for injection into the pipeline. For instance, hydrogen gas can be injected into a natural gas pipeline to reduce the carbon intensity of the fluid flowing through the pipeline (e.g., reduce the carbon footprint of the fluid flowing through the pipeline). As another example, it is also contemplated that the hydrogen gas can be fed to a hydrogen pipeline for transport via that pipeline instead of being injected into a natural gas pipeline. Additionally (or as another alternative), the hydrogen gas can be used in a hydrogen fuel cell to generate back-up power for the facility.

The hydrogen produced for liquefaction in such systems can be hydrogen produced by one or more electrolyzers, one or more ammonia dissociation units (e.g., ammonia dissociator, etc.) or other hydrogen producing units. Hydrogen gas output from hydrogen production can be fed to a compression system for compressing the hydrogen before the compressed hydrogen is fed to a liquefaction unit, which can include one or more liquefiers. Hydrogen gas formed from liquid hydrogen stored in one or more trailers can be fed to the compression system or to the liquefaction unit for being returned to the liquefaction unit for liquefaction, so the hydrogen is not lost to the atmosphere. In other implementations, the hydrogen gas output from the trailer(s) can be used to help cool the compressed hydrogen gas output from the compression system being fed to the liquefaction unit prior to the hydrogen gas from the trailer(s) being fed to a pipeline or a turbine. In yet other implementations, it is contemplated that the hydrogen output from the one or more trailers can be utilized for two or more of these applications (e.g., injection into a pipeline, cooling of the compressed hydrogen feed gas before it is fed to the liquefaction unit, feeding the hydrogen gas to the compression system and/or feeding the hydrogen gas to the turbine).

We have determined that embodiments of our process and apparatus can provide surprising improvements in efficiency and flexible operation. Embodiments can also be configured to help avoid venting of hydrogen gas to the atmosphere from trailers while those trailers are being filled with liquid hydrogen and/or storing that liquid hydrogen on-site before leaving to deliver the liquid hydrogen to a remote, off-site location.

In a first aspect, an apparatus for utilization of hydrogen gas output from at least one trailer is provided. The apparatus can be utilized as a plant, can be incorporated into a plant, or may be retrofit into a pre-existing plant in some embodiments. The apparatus can include at least one trailer positionable to receive liquified hydrogen and store the liquified hydrogen therein such that a portion of the liquid hydrogen vaporizes into hydrogen gas while the liquified hydrogen is stored in the trailer. The at least one trailer can be connectable to a turbine, a pipeline, a fuel cell, a storage unit, a liquefaction unit and/or a compression system for feeding hydrogen gas formed within the trailer storing the liquified hydrogen to the liquefaction unit, the compression system, the fuel cell, the storage unit, the turbine and/or the pipeline.

Embodiments can be configured so that the connection the trailer can have for transport of hydrogen gas formed within the trailer can be provided while the trailer is being filled with liquified hydrogen or while the trailer is storing the liquified hydrogen and has yet to leave a facility to transport that liquid hydrogen to another location.

In a second aspect, the apparatus can also include a heat exchanger positioned between the liquefaction unit and the at least one trailer to cool a feed of hydrogen output from the compression system via the hydrogen gas output from the at least one trailer before the hydrogen output from the compression system is fed to the liquefaction unit. The hydrogen gas output from the at least one trailer fed to the heat exchanger can be output from the heat exchanger as a warmed flow of hydrogen gas.

The heat exchanger can be positioned so that the warmed flow of hydrogen gas output from the heat exchanger is feedable to the turbine, is injectable into the pipeline, is feedable to a storage unit, is feedable to a fuel cell, and/or is feedable to a compression system. In embodiments where at least a portion of the warmed hydrogen gas output from the heat exchanger is feedable to the pipeline, the pipeline can be a natural gas pipeline and the portion of the warmed flow of hydrogen gas output from the heat exchanger for being injected into the pipeline can be injectable into the pipeline to reduce a carbon intensity of fluid within the pipeline. Alternatively, the pipeline that receives the warmed hydrogen gas can be a hydrogen pipeline.

In a third aspect, the apparatus can be configured so that the at least one trailer is connectable to the liquefaction unit for feeding the hydrogen gas formed within the trailer storing the liquified hydrogen to the liquefaction unit. The liquefaction unit can comprise at least one liquefier. In some embodiments, the liquefaction unit can include a first liquefier and at least one second liquefier and the at least one trailer can be connectable to the liquefaction unit so that the hydrogen gas is fed to only the first liquefier. In some implementations, this first liquefier may be a larger liquefier than the one or more other second liquefiers.

In some embodiments, the first liquefier can be configured as a trailer hydrogen reliquefier such that the first liquefier can be dedicated to reliquefaction of the hydrogen gas output from the trailer(s) while one or more second liquefiers of the liquefaction unit can perform liquefaction of the hydrogen gas received from the compression system. This type of arrangement can permit the liquefaction unit to have a simpler design and permit the first liquefier to be of a simpler design (e.g. the reliquefaction of the trailer hydrogen gas may not need use of ortho-hydrogen to para-hydrogen conversion elements for the liquefaction of the trailer hydrogen gas). Such an embodiment can be configured so that a liquefaction train of the liquefaction unit can utilize simpler load management. For example, de-coupling the re-liquefaction of the trailer hydrogen gas via a dedicated first liquefier can lower operational swings on the liquefaction unit and minimize any contamination effects on the other liquefier(s) of the liquefaction unit. It is contemplated that this type of embodiment can help provide greater operational efficiency and/or operational flexibility as well.

In a fourth aspect, the apparatus can be provided so that the at least one trailer is connectable to the compression system for feeding the hydrogen gas formed within the trailer storing the liquified hydrogen to the compression system for undergoing compression before being fed to the liquefaction unit. The compression system can be connected to the liquefaction unit to feed compressed fluid comprising hydrogen gas to the liquefaction unit. In some embodiments, the compression system can comprise a first compressor.

In a fifth aspect, the apparatus can be configured so that the at least one trailer is connectable to the turbine, the pipeline, the fuel cell, the storage unit, the liquefaction unit and/or the compression system such that a first portion of the liquid hydrogen that is greater than 0% and less than 15% of the liquid hydrogen fed to the at least one trailer for storage therein is vaporized and subsequently fed as the hydrogen gas formed within the trailer storing the liquified hydrogen to the liquefaction unit, the compression system, the fuel cell, the storage unit, the turbine and/or the pipeline and a second portion of the liquid hydrogen that is less than or equal to 85% and less than 100% of the liquid hydrogen fed to the at least one trailer is retained and stored in the at least one trailer.

In a sixth aspect, the apparatus of the first aspect can include two or more of the second aspect, third aspect, fourth aspect, and fifth aspects. In some configurations, the apparatus of the first aspect can include all of the features of the second, third, fourth, and fifth aspects as well as other features. In other configurations, only a subpart of such features of these aspects with or without other features may be provided.

In a seventh aspect, a process for utilization of hydrogen gas output from at least one trailer is provided. In some embodiments, the process can be employed while the at least one trailer is being filled with liquid hydrogen or is storing liquid hydrogen for being subsequently transported to a remote location. The process can include forming hydrogen gas from liquid hydrogen stored within at least one trailer. In some embodiments, the hydrogen gas formation can occur while the at least one trailer is being filled with liquid hydrogen and/or while that at least one trailer is storing the liquid hydrogen. The process can also include feeding the hydrogen gas from the at least one trailer to a pipeline, a storage unit, a fuel cell, a turbine, a liquefaction unit for subsequent liquefaction of the hydrogen gas and/or a compression system for compression of the hydrogen gas for subsequent liquefaction of compressed hydrogen gas output from the compression system via a liquefaction unit connected to the compression system.

In embodiments where at least a portion of the hydrogen gas is feedable to the pipeline, the pipeline can be a natural gas pipeline and the portion of the hydrogen gas can be injectable into the pipeline to reduce a carbon intensity of fluid within the pipeline.

In an eighth aspect, the process can include feeding the hydrogen gas from the at least one trailer to a heat exchanger positioned between the compression system and the liquefaction unit to cool a feed of compressed hydrogen gas output from the compression system via the hydrogen gas output from the at least one trailer before the compressed hydrogen gas output from the compression system is fed to the liquefaction unit. The process can also include the heat exchanger outputting the hydrogen gas received from the at least one trailer as a warmed flow of hydrogen gas for feeing to the pipeline, the fuel cell, the storage unit, the turbine or the compression system.

Embodiments of this aspect can be implemented so that the warmed flow of hydrogen gas output from the heat exchanger is fed to the turbine, the pipeline, the fuel cell, the storage unit, and/or the compression system. In some implementations, for example, at least a portion of the warmed flow of hydrogen gas output from the heat exchanger can be fed to the pipeline. The pipeline can be a natural gas pipeline and the warmed flow of hydrogen gas output from the heat exchanger can be injectable into the pipeline to reduce a carbon intensity of fluid within the pipeline.

In a ninth aspect, the process can be implemented so that the feeding of the hydrogen gas from the at least one trailer to the pipeline, the fuel cell, the storage unit, the turbine, the liquefaction unit for subsequent liquefaction of the hydrogen gas and/or the compression system for compression of the hydrogen gas for subsequent liquefaction of compressed hydrogen gas output from the compression system via the liquefaction unit connected to the compression system includes feeding the hydrogen gas formed within the trailer storing the liquified hydrogen to the compression system for undergoing compression before being fed to the liquefaction unit. The compression system can comprise a first compressor and at least one second compressor connected to the first compressor in some embodiments. In other embodiments, the compression system may only include a first compressor or may include more than two compressors.

In a tenth aspect, the process can be implemented so that the feeding of the hydrogen gas from the at least one trailer to the pipeline, the storage unit, the fuel fell, the turbine, the liquefaction unit for subsequent liquefaction of the hydrogen gas and/or the compression system for compression of the hydrogen gas for subsequent liquefaction of compressed hydrogen gas output from the compression system via the liquefaction unit connected to the compression system includes feeding the hydrogen gas from the at least one trailer to the liquefaction unit for liquefaction of the hydrogen gas. In some embodiments, the liquefaction unit can include a first liquefier and at least one second liquefier and the hydrogen gas from the at least one trailer can be fed only to the first liquefier for liquefaction. In other embodiments, the liquefaction unit may only have a first liquefier or may have multiple liquefiers and the hydrogen gas can be fed to all the liquefiers of the liquefaction unit or at least two or more of those liquefiers.

In some embodiments of the process, the first liquefier can be configured as a trailer hydrogen reliquefier such that the first liquefier can be dedicated to reliquefaction of the hydrogen gas output from the trailer(s) while one or more second liquefiers of the liquefaction unit can perform liquefaction of the hydrogen gas received from the compression system. As noted above, this type of arrangement can permit the liquefaction unit to have a simpler design and permit the first liquefier to be of a simpler design (e.g. the reliquefaction of the trailer hydrogen gas may not need use of ortho-hydrogen to para-hydrogen conversion elements for the liquefaction of the trailer hydrogen gas). Such an embodiment can be configured so that a liquefaction train of the liquefaction unit can utilize simpler load management. For example, de-coupling the re-liquefaction of the trailer hydrogen gas via a dedicated first liquefier can lower operational swings on the liquefaction unit and minimize any contamination effects on the other liquefier(s) of the liquefaction unit. It is contemplated that this type of embodiment of the process can help provide greater operational efficiency and/or operational flexibility as well.

In an eleventh aspect, the process can be implemented so that the forming of the hydrogen gas from liquid hydrogen stored within the at least one trailer occurs such that a first portion of the liquid hydrogen that is greater than 0% and less than 15% of the liquid hydrogen fed to the at least one trailer for storage therein is vaporized and subsequently fed as the hydrogen gas formed within the trailer storing the liquified hydrogen to the liquefaction unit, the compression system, the fuel cell, the storage unit, the turbine and/or the pipeline and a second portion of the liquid hydrogen that is less than or equal to 85% and less than 100% of the liquid hydrogen fed to the at least one trailer is retained and stored in the at least one trailer.

In a twelfth aspect, embodiments of the process can also include providing an embodiment of the apparatus for use in a plant or facility or retrofitting a plant or facility to include an embodiment of the apparatus.

In a thirteenth aspect, the feeding of the hydrogen gas from the at least one trailer can be performed in response to determining that an availability of renewable power for production of hydrogen is at or below a pre-selected threshold. For example, the feeding of the hydrogen gas from the at least one trailer can be performed at night when renewable power via solar power that can be utilized for hydrogen production may be non-existent or very low.

In a fourteenth aspect, embodiments of the apparatus discussed above or otherwise discussed herein can be provided to implement an embodiment of the process for utilization of hydrogen gas output from at least one trailer.

In a fifteenth aspect, the process of the seventh aspect can be combined with one or more of the eighth aspect, the ninth aspect, the tenth aspect, the eleventh aspect, the twelfth aspect, the thirteen aspect and the fourteenth aspect. Some embodiments of the fifteenth aspect can include the seventh aspect being combined with two or more of these aspects, only one of these aspects, or all of these aspects. Other embodiments of the fifteenth aspect can be provided so that subparts of one or more of these aspects can be combined with the seventh aspect to provide an embodiment of the process.

It should be appreciated that embodiments of the process and apparatus can utilize various conduit arrangements and process control elements. The embodiments may utilize sensors (e.g., pressure sensors, temperature sensors, flow rate sensors, concentration sensors, etc.), controllers, valves, piping, and other process control elements. Some embodiments can utilize an automated process control system and/or a distributed control system (DCS), for example. Various different conduit arrangements and process control systems can be utilized to meet a particular set of design criteria.

Other details, objects, and advantages of our process for utilization of hydrogen gas output from at least one trailer, an apparatus for utilization of hydrogen gas output from at least one trailer, and methods of making and using the same will become apparent as the following description of certain exemplary embodiments thereof proceeds.

### BRIEF DESCRIPTION OF THE DRAWINGS

Exemplary embodiments of processes for utilization of hydrogen gas output from at least one trailer, apparatuses for utilization of hydrogen gas output from at least one trailer, and systems for utilization of hydrogen gas output from at least one trailer, and methods of making and using the same are shown in the drawings included herewith. It should be understood that like reference characters used in the drawings may identify like components.

FIG. 1 is a block diagram of a first exemplary embodiment of an apparatus 1 for utilization of hydrogen gas output from at least one trailer. FIG. 1 also illustrates a first exemplary embodiment of a process for utilization of hydrogen gas output from at least one trailer.

FIG. 2 is a flow chart illustrating an exemplary embodiment of a process for utilization of hydrogen gas output from at least one trailer. Exemplary embodiments of the apparatus 1 shown in FIGS. 1 and 3-9 can be adapted to implement the exemplary embodiment of the process shown in FIG. 2.

FIG. 3 is a block diagram of a first exemplary implementation of the first exemplary embodiment of the apparatus 1 for utilization of hydrogen gas output from at least one trailer.

FIG. 4 is a block diagram of a second exemplary implementation of the first exemplary embodiment of the apparatus 1 for utilization of hydrogen gas output from at least one trailer.

FIG. 5 is a block diagram of a third exemplary implementation of the first exemplary embodiment of the apparatus 1 for utilization of hydrogen gas output from at least one trailer.

FIG. 6 is a block diagram of a fourth exemplary implementation of the first exemplary embodiment of the apparatus 1 for utilization of hydrogen gas output from at least one trailer.

FIG. 7 is a block diagram of a fifth exemplary implementation of the first exemplary embodiment of the apparatus 1 for utilization of hydrogen gas output from at least one trailer.

FIG. 8 is a block diagram of a sixth exemplary implementation of the first exemplary embodiment of the apparatus 1 for utilization of hydrogen gas output from at least one trailer.

FIG. 9 is a block diagram of a seventh exemplary implementation of the first exemplary embodiment of the apparatus 1 for utilization of hydrogen gas output from at least one trailer.

### DETAILED DESCRIPTION

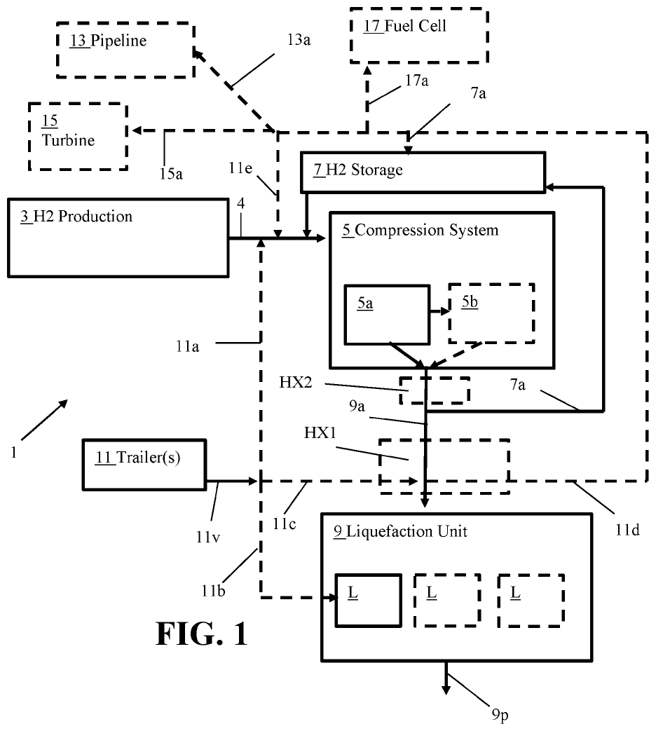

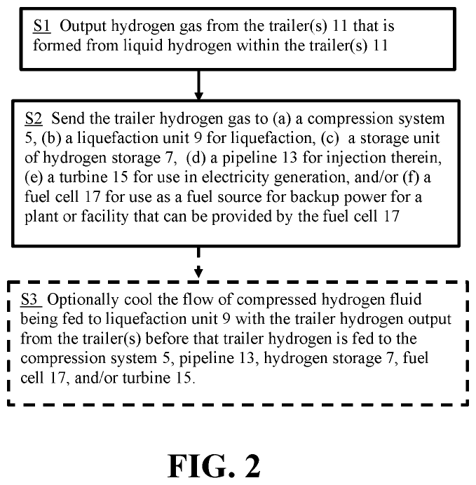

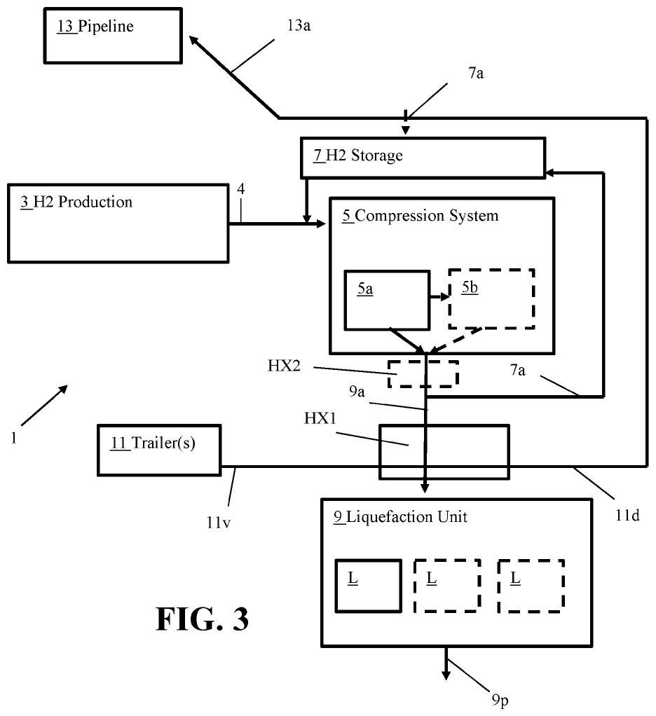

As noted above, FIG. 1 illustrates exemplary embodiments of our apparatus 1 for utilization of hydrogen gas output from at least one trailer. These exemplary embodiments of the apparatus 1 can utilize an exemplary embodiment of our process for utilization of hydrogen gas output from at least one trailer. FIGS. 3-9 illustrate exemplary implementations of the embodiment of the apparatus shown in FIG. 1. Embodiments of the apparatus 1 can be configured to practice or implement an embodiment of our process for utilization of hydrogen gas output from at least one trailer. FIG. 2 illustrates a flow chart of an exemplary embodiment of such a process. Examples of processes for utilization of hydrogen gas output from at least one trailer can also be appreciated from FIGS. 1 and 3-9.

Referring to FIGS. 1 and 3-9, an apparatus 1 can include a unit for hydrogen production 3, which can also be referred to as a hydrogen production unit (H2 Production). The unit for hydrogen production 3 can include one or more electrolyzers or at least one ammonia dissociator (e.g., for utilization in a green hydrogen production manufacturing implementation). It is also contemplated that the unit for hydrogen production 3 can include at least one methane reformer or other hydrogen production device that includes carbon capture devices to remove carbon dioxide and carbon monoxide from the emissions of the H2 production process to minimize the carbon footprint of the hydrogen production (e.g., a blue hydrogen type hydrogen production arrangement).

Hydrogen gas output from the unit for hydrogen production 3 can be fed to a compression system 5 via a compression system feed conduit 4 that is positioned between the unit for hydrogen production 3 and the compression system 5. For example, the compression system feed conduit 4 can feed hydrogen gas output from the unit for hydrogen production 3 to a first compressor 5a (e.g., a low pressure (LP) compressor) of the compression system 5. The first compressor 5a can compress the hydrogen to a first pre-selected pressure for output of the hydrogen when the first pre-selected pressure is the desired pre-selected compression system output pressure. In implementations where additional compression may be needed to pressurize the hydrogen to the pre-selected compression system output pressure, the compressed hydrogen output from the first compressor 5a can be fed from the first compressor 5a to at least one second compressor 5b (shown in broken line) for further compression to the pre-selected compression system output pressure.

The pre-selected compression system output pressure can be a suitable pressure for feeding the hydrogen gas to a liquefaction unit. Examples of a pre-selected compression system output pressure can include a pressure of 2-20 MPa, a pressure of 2-30 MPa, a pressure of 5-20 MPa, or a pressure of 2-45 MPa, for example. Other pressures or pressure ranges can alternatively be utilized as well depending on a pre-selected set of design and operational criteria.

The compression system 5 can output the compressed hydrogen gas at the pre-selected compression system output pressure for feeding to a liquefaction unit 9 via a liquefaction feed conduit 9a positioned between the liquefaction unit 9 and the compression system 5. In some situations, a portion of the hydrogen can also be output for hydrogen storage 7 (H2 storage) for storage and subsequent use. For instance, a portion of compressed hydrogen output from the compression system 5 can be fed to at least one hydrogen storage vessel of hydrogen storage 7 via a hydrogen storage feed conduit 7a that is positioned between the hydrogen storage 7 and the compression system 5.

Hydrogen can be stored in at least one vessel of a hydrogen storage unit for hydrogen storage 7 so that the hydrogen from the storage unit can be output to the compression system 5 for being compressed back to the pre-selected compression system output pressure for feeding to the liquefaction unit 9 to account for different situations. For instance, hydrogen gas from hydrogen storage can be fed to the compression system 5 via a hydrogen storage output conduit positioned between the hydrogen storage 7 and the compression system 5 so that the hydrogen can be compressed for feeding to the liquefaction unit 9 when hydrogen production from the unit for hydrogen production 3 has unexpectedly slowed (e.g. due to a low availability of renewable energy due to weather conditions, etc.) or to facilitate an increase in output in situations where the demand for liquefaction increases unexpectedly and production is to be ramped up to accommodate the increased demand.

The liquefaction unit 9 can include at least one liquefier L. In some embodiments, the liquefaction unit can include a plurality of liquefiers that include a first liquefier L as well as at least one second liquefier L (shown in broken line). The liquefiers can liquify the compressed hydrogen gas received from the compression system 5 for producing at least one liquified hydrogen stream 9p. The liquified hydrogen stream 9p can be considered a hydrogen product stream. The liquified hydrogen stream 9p can be fed to at least one trailer 11 and/or provided to other units for storage for being subsequently fed to at least one trailer 11.

At least one trailer 11 can receive the liquefied hydrogen output from the liquefaction unit 9 via the liquified hydrogen stream 9p. Each trailer 11 can be a tube trailer or other type of trailer suitable for the transportation of liquid hydrogen. The liquified hydrogen can be provided via at least one liquified hydrogen trailer feed conduit that is positioned between the trailer(s) 11 and the liquefaction unit 9. In some implementations, the liquified hydrogen can be stored in an intermediate product storage device (not shown) prior to being fed to the trailer(s) 11. As the trailer 11 is filled with liquified hydrogen and/or stores the liquified hydrogen before it is transported off-site, a portion of the liquified hydrogen can vaporize to gaseous hydrogen. This gaseous hydrogen can be output from the trailer 11 for subsequent use via a trailer hydrogen gas output conduit 11v of the apparatus 1.

The trailer(s) 11 can also be trailers that were previously used to deliver liquid hydrogen and have returned to the site to be refilled with liquid hydrogen, but also may retain some depress hydrogen gas that can be present as a consequence of emptying the trailer for delivery of the liquid hydrogen. Such hydrogen gas can be considered depress hydrogen gas, for example. The trailer(s) 11 can provide this residual hydrogen vapor so it is emptied from the trailer for use prior to trailer being filled with liquid hydrogen for a subsequent delivery. This gaseous hydrogen can also be output from the trailer(s) 11 for subsequent use via a trailer hydrogen gas output conduit 11v of the apparatus 1.

FIG. 1 illustrates various different flow path arrangements for providing the hydrogen gas from the trailer(s) 11 to one or more devices (e.g., turbine 15, storage unit of hydrogen storage 7, pipeline 13, compression system 5, liquefaction unit 9, first liquefier L of the liquefaction unit 9, a fuel cell 17, etc.). The various different flow paths for utilization of the hydrogen gas output from the trailer(s) 11 via the trailer hydrogen gas output conduit 11v are indicated in broken line FIG. 1. It should be appreciated that FIGS. 3-9 illustrate in solid line various different implementations shown in broken line in FIG. 1 to provide yet additional illustrated examples of various different implementation options for the exemplary embodiment of the apparatus 1 shown in FIG. 1. As can be appreciated from the disclosure provided herein, there are yet other implementation options for the embodiment of FIG. 1 in addition to the exemplary implementations shown in FIGS. 3-9.

As may be best appreciated from FIGS. 1 and 3-9, the hydrogen vapor, or hydrogen gas, formed from the liquified hydrogen stored in the trailer(s) 11 while feeding the liquid hydrogen to the trailer(s) 11 and/or while the liquid hydrogen is stored in the trailer(s) 11 can be output from the trailer(s) 11 via at least one trailer hydrogen gas output conduit 11v. The hydrogen gas output from the trailer(s) 11 can be fed to the liquefaction unit 9 via a liquefaction feed conduit 11c that can be connected to the trailer hydrogen gas output conduit 11v and/or can be fed to a first liquefier L of a plurality of liquefiers L of the liquefaction unit via a first liquefier feed conduit 11b that can be connected to the trailer hydrogen gas output conduit 11v.

In some embodiments, the first liquefier L can be configured as a trailer hydrogen reliquefier such that the first liquefier can be dedicated to reliquefaction of the hydrogen gas output from the trailer(s) 11 while one or more second liquefiers L of the liquefaction unit 9 can perform liquefaction of the hydrogen gas received from the compression system 5. This type of arrangement can permit the liquefaction unit 9 to have a simpler design and permit the first liquefier L to be of a simpler design (e.g. the reliquefaction of the trailer hydrogen gas may not need use of ortho-hydrogen to para-hydrogen conversion elements for the liquefaction of the trailer hydrogen gas). Such an embodiment can be configured so that a liquefaction train of the liquefaction unit 9 can utilize simpler load management for reliquefaction of the trailer hydrogen gas and provide other operational benefits. For example, de-coupling the re-liquefaction of the trailer hydrogen gas via a dedicated first liquefier L can lower operational swings on the liquefaction unit 9 and minimize any contamination effects on the other liquefier(s) of the liquefaction unit 9. It is contemplated that this type of embodiment can help provide greater operational efficiency and/or operational flexibility as well.

Also, (or alternatively), the hydrogen gas fed to the trailer hydrogen gas output conduit 11v via the trailer(s) 11 can be fed to a storage unit of hydrogen storage 7 via a hydrogen storage feed conduit 7a connected to the trailer hydrogen gas output conduit 11v and/or can be fed to the compression system 5 via a trailer hydrogen gas compression system feed conduit 11a connected to the trailer hydrogen gas output conduit 11v. The feeding of the hydrogen gas output from the trailer(s) 11 can be via the trailer hydrogen gas compression system feed conduit 11a to provide a more direct connection between the trailer(s) 11 and the compression system 5 or can be via a less direct connection in which the hydrogen gas output from the trailer(s) 11 is first used as a cooling medium in a first heat exchanger HX1 to cool the compressed hydrogen gas output from the compression system 5 to cool that compressed hydrogen to a pre-selected liquefaction feed temperature before that compressed hydrogen is fed to the liquefaction unit 9.

In some embodiments, the first heat exchanger HX1 can be positioned downstream from a second heat exchanger HX2 (shown in broken line in FIGS. 1 and 3-9). The second heat exchanger HX2 can be, for example, an ambient heat exchanger that utilizes air or cooling water as a cooling medium to cool the compressed hydrogen output from the compression system 5. The first heat exchanger HX1 can be utilized downstream of the second heat exchanger HX2 to provide additional cooling when this second heat exchanger HX2 is also used so that the first heat exchanger HX1 can provide additional pre-cooling prior to liquefaction of the compressed hydrogen. Alternatively, it is contemplated that the first heat exchanger HX1 can be positioned and configured so that the second heat exchanger HX2 may not be needed.

The pre-selected liquefaction feed temperature can be a temperature within a pre-selected range of liquefaction feed temperatures selected to meet a pre-selected set of design and/or operational criteria. Examples of a pre-selected feed temperature can include a temperature within the range of −10° C. to 0° C., −25°C. to 20° C., or −20° C. to 25° C. Of course, other temperatures can also be utilized as noted herein.

For example, the hydrogen gas output from the trailer(s) 11 can be fed to the first heat exchanger HX1 via a heat exchanger conduit arrangement 11d that can be positioned to feed the hydrogen gas output from the trailer(s) 11 to the first heat exchanger HX1 and also feed the warmed trailer hydrogen gas cooling medium that is output from the first heat exchanger HX1 to the compression system 5 via a warmed trailer hydrogen feed conduit 11e connected between the heat exchanger conduit arrangement 11d and the compression system 5.

Alternatively (or also), the warmed trailer hydrogen gas output from the first heat exchanger HX1 can be fed to a pipeline 13 for injection into the pipeline via a pipeline feed conduit 13a connected between the heat exchanger conduit arrangement 11d and the pipeline 13. The pipeline 13 can be a hydrogen pipeline in which the trailer hydrogen gas can be fed for distribution via the pipeline 13 or can be a natural gas pipeline. In situations where the pipeline 13 is a natural gas pipeline, the trailer hydrogen gas can be injected therein to help reduce the carbon intensity of the natural gas being passed through the pipeline to help reduce the carbon footprint of the natural gas.

Also, (or as yet another alternative), the warmed trailer hydrogen gas output from the first heat exchanger HX1 can be fed to a turbine 15 (e.g., a hydrogen turbine) for combustion or expansion therein via a turbine feed conduit 15a connected between the heat exchanger conduit arrangement 11d and the turbine 15. The turbine 15 can utilize the hydrogen from the trailer(s) 11 as a source for power generation or electricity generation, for example.

Also, (or as yet another alternative), the warmed trailer hydrogen gas output from the first heat exchanger HX1 can be fed to a fuel cell 17 (e.g., a hydrogen fuel cell) via a fuel cell feed conduit 17a connected between the heat exchanger conduit arrangement 11d and the fuel cell 17. The fuel cell can be configured to receive the hydrogen for use as a fuel source for providing backup power for the apparatus or plant having the apparatus.

A compressor can be included in a trailer hydrogen gas conduit to facilitate the flow of hydrogen gas from the trailer(s) 11 to one or more elements. Such a compressor can be provided as a dedicated trailer/flash gas compressor to recover the hydrogen with or without refrigeration recovery.

As noted above, FIGS. 3-9 illustrate different implementations of the options discussed above. For example, FIG. 3 illustrates an exemplary implementation of the apparatus 1 of FIG. 1 in which the first heat exchanger HX1 is utilized and the heat exchanger conduit arrangement 11d is positioned so that the warmed trailer hydrogen gas output from the first heat exchanger HX1 is fed to the pipeline 13 via pipeline feed conduit 13a for injection therein. The trailer hydrogen gas in this implementation can cool the compressed hydrogen gas output from the compression system 5 at the pre-selected compression system output pressure to cool that gas to the pre-selected liquefaction unit feed temperature for feeding to the liquefaction unit 9 for liquifying the hydrogen.

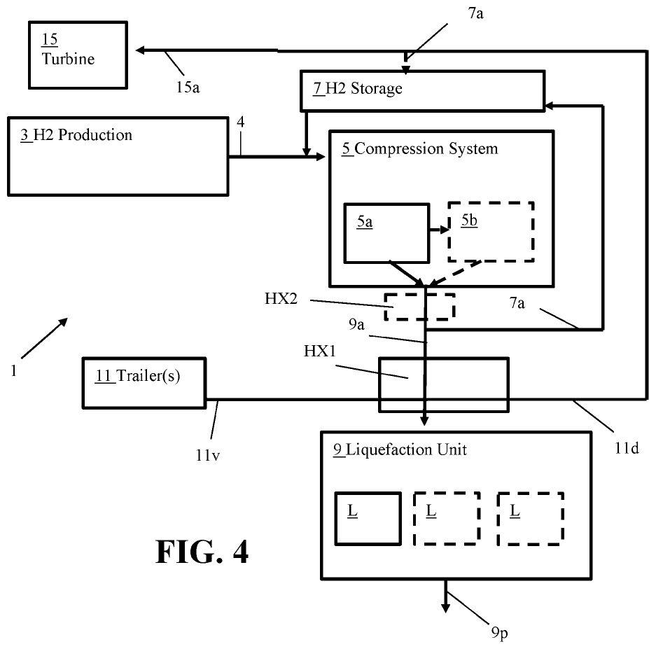

FIG. 4 illustrates an exemplary implementation of the apparatus 1 of FIG. 1 in which the first heat exchanger HX1 is utilized and the heat exchanger conduit arrangement 11d is positioned so that the warmed trailer hydrogen gas output from the first heat exchanger HX1 is fed to the turbine 15 via turbine feed conduit 15a for being combusted or expanded therein for power generation or electricity generation. The trailer hydrogen gas in this implementation can cool the compressed hydrogen gas output from the compression system 5 at the pre-selected compression system output pressure to the pre-selected liquefaction unit feed temperature for feeding to the liquefaction unit 9 via the liquefaction feed conduit 9a for liquifying the hydrogen.

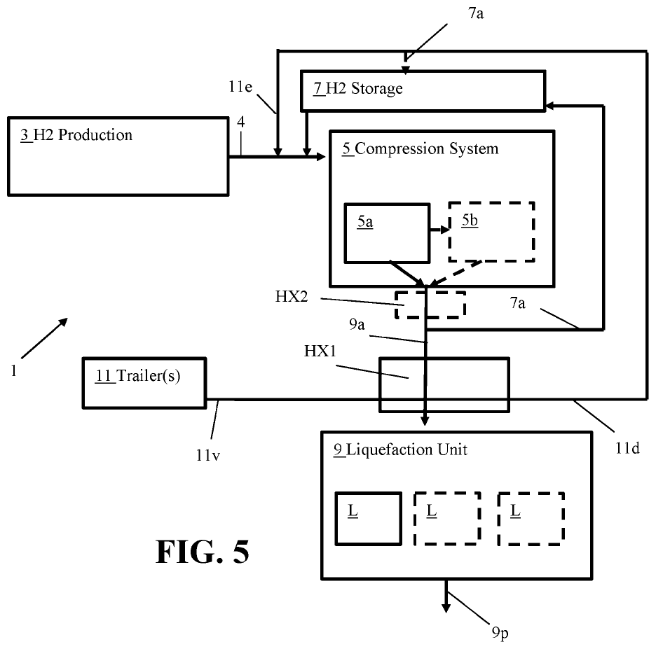

FIG. 5 illustrates an exemplary implementation of the apparatus 1 of FIG. 1 in which the first heat exchanger HX1 is utilized and the heat exchanger conduit arrangement 11d is positioned so that the warmed trailer hydrogen gas output from the first heat exchanger HX1 is fed to the compression system 5 via the hydrogen feed conduit 11e connected between the heat exchanger conduit arrangement 11d and the compression system 5. The trailer hydrogen gas in this implementation can cool the compressed hydrogen gas output from the compression system 5 at the pre-selected compression system output pressure so it can be cooled to the pre-selected liquefaction unit feed temperature for feeding to the liquefaction unit 9 via the liquefaction feed conduit 9a for liquifying the hydrogen.

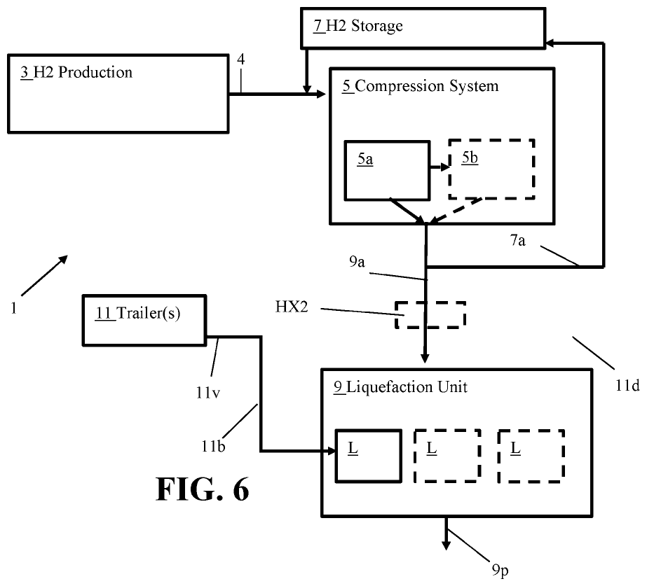

FIG. 6 illustrates an exemplary implementation of the apparatus 1 of FIG. 1 in which the hydrogen gas output from the trailer(s) 11 is fed to a first liquefier L of the liquefaction unit 9 via a first liquefier feed conduit 11b connected between the trailer(s) 11 and the first liquefier L of the liquefaction unit 9. This type of arrangement can be particularly beneficial for a liquefaction unit 9 that may utilize multiple liquefiers L that operate in parallel to liquify the hydrogen. For instance, the added hydrogen gas from the trailer(s) 11 can be provided so that the first liquefier L that receives the trailer hydrogen gas is sized to be larger than the other liquefiers L of the liquefaction unit 9. This can permit other smaller liquefiers to be utilized in a train of liquefiers of the liquefaction unit 9 so that only a single liquefier L is sized to accommodate the added hydrogen available via the trailer(s) 11. Such an arrangement of liquefiers can permit the capital costs associated with the liquefiers to be lower than having multiple liquefiers all sized to be larger and can also permit more flexible processing operations by providing one liquefier with a larger liquefaction capacity.

As noted above, in some embodiments of this exemplary implementation in which the hydrogen gas from the trailer(s) 11 is fed to only the first liquefier L, the first liquefier L can be configured as a trailer hydrogen reliquefier such that the first liquefier L can be dedicated to reliquefaction of the hydrogen gas output from the trailer(s) 11 while one or more second liquefiers L of the liquefaction unit 9 can perform liquefaction of the hydrogen gas received from the compression system 5. This type of arrangement can permit the liquefaction unit 9 to have a simpler design and permit the first liquefier L to be of a simpler design (e.g. the reliquefaction of the trailer hydrogen gas may not need use of ortho-hydrogen to para-hydrogen conversion elements for the liquefaction of the trailer hydrogen gas). Such an embodiment can be configured so that a liquefaction train of the liquefaction unit 9 can utilize simpler load management for reliquefaction of the trailer hydrogen gas and provide other operational benefits. For example, de-coupling the re-liquefaction of the trailer hydrogen gas via a dedicated first liquefier L can lower operational swings on the liquefaction unit 9 and minimize any contamination effects on the other liquefier(s) of the liquefaction unit 9. It is contemplated that this type of embodiment can help provide greater operational efficiency and/or operational flexibility as well.

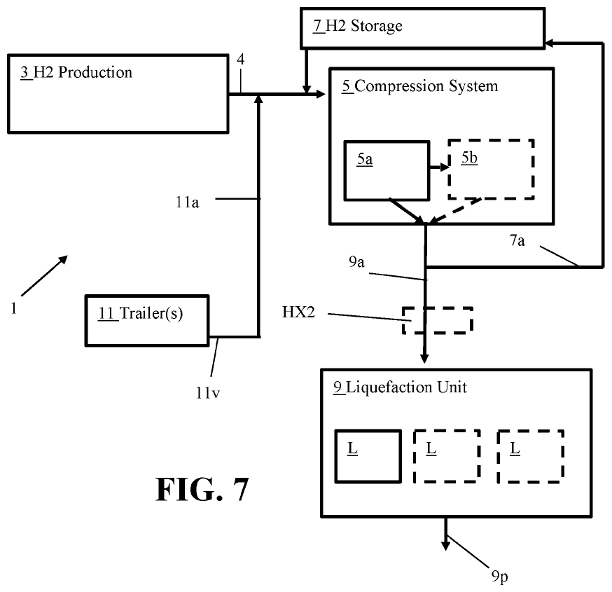

FIG. 7 illustrates an exemplary implementation of the apparatus 1 of FIG. 1 in which the hydrogen gas output from the trailer(s) 11 is fed to the compression system 5 via a trailer hydrogen gas compression system feed conduit 11a connected between the compression system 5 and the trailer(s) 11 The hydrogen gas output from the trailer(s) 11 in this implementation can undergo compression via the compression system 5 before being returned to the liquefaction unit 9 to be liquified via at least one liquefier L of the liquefaction unit 9.

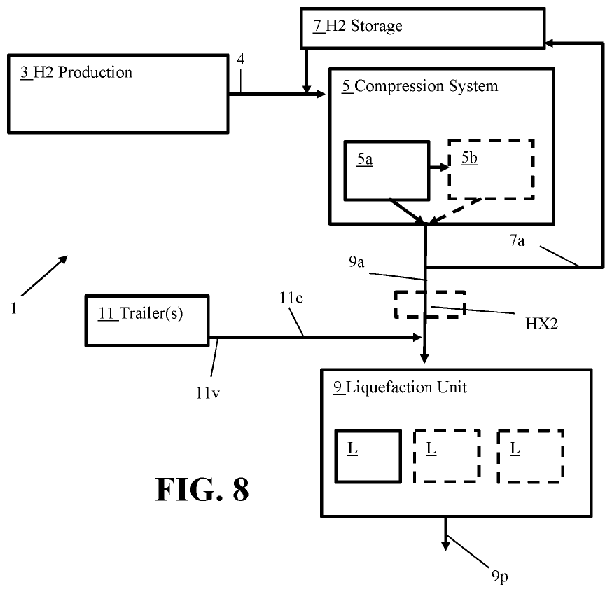

FIG. 8 illustrates an exemplary implementation of the apparatus 1 of FIG. 1 in which the hydrogen gas output from the trailer(s) 11 is fed to the liquefaction unit 9 via a trailer hydrogen gas liquefaction feed conduit 11c connected between the liquefaction unit 9 and the trailer(s) 11. The hydrogen gas output from the trailer(s) 11 in this implementation can be fed to the liquefaction unit 9 to be liquified via at least one liquefier L of the liquefaction unit 9.

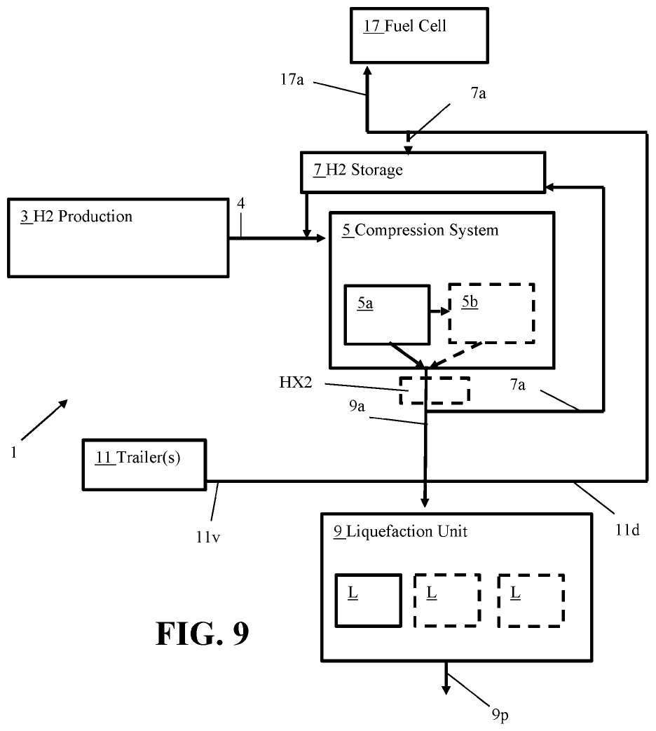

FIG. 9 illustrates an exemplary implementation of the apparatus 1 of FIG. 1 in which the hydrogen gas output from the trailer(s) 11 is fed to at least one fuel cell 17 via a trailer hydrogen gas feed conduit connected between the fuel cell feed conduit 17a and the trailer(s) 11 The hydrogen gas output from the trailer(s) 11 in this implementation can be fed to one or more hydrogen fuel cells for generation of backup power for plant or facility operations.

As may be appreciated from FIGS. 1, 3, 4, 5, and 9, the hydrogen gas output from the trailer(s) 11 can also (or alternatively) be fed to a storage unit of hydrogen storage 7 via a hydrogen storage feed conduit 7a (shown in broken line) connected between the storage unit of the hydrogen storage 7 and the trailer(s) 11. The hydrogen gas output from the trailer(s) 11 in this implementation can be stored for subsequently being fed to the compression system 5 to undergo compression via the compression system 5 before being returned to the liquefaction unit 9 to be liquified via at least one liquefier L of the liquefaction unit 9. Feeding of hydrogen gas to storage in such an implementation may occur in combination with feeding the hydrogen gas to one or more other elements or as an alternative such that all the hydrogen gas output from the trailer(s) 11 can be fed to a storage unit for hydrogen storage and later use.

Embodiment of the apparatus 1 can also utilize at least one controller. The controller can be communicatively connected to concentration sensors, pressure sensors, temperature sensors, flow sensors, valves, and/or other elements to facilitate automated process control of the apparatus 1. For instance, in some embodiments, the controller can be a workstation that runs an automated process control software via a processor and can be communicatively connected to sensors and other elements to facilitate monitoring and control of the operation of the apparatus 1. In other situations, the controller can be part of a DCS system adapted to monitor and control operations of the apparatus 1. It should be appreciated that the controller can be a computer device that includes a processor connected to a non-transitory computer readable medium (e.g., non-transitory memory) and at least one transceiver unit for communicative connections to other process control elements (e.g., sensors, detectors, valves, etc.).

In some implementations, the composition of the trailer hydrogen gas can be analyzed before it is sent back to the compression system 5 and/or hydrogen storage 7 so that the hydrogen gas stream can be analyzed to verify that the hydrogen gas may not have impurities or other elements that could possibly contaminate the hydrogen liquefaction processing or cause other unexpected issues. Such an analysis can also be performed before the hydrogen gas is fed to the fuel cell 17, turbine 15 or pipeline 13 in some embodiments. The compositional analysis can be performed by a composition analyzer, sample extraction and subsequent testing, or other composition detection and analysis scheme. The compositional analysis can also, or alternatively, be performed by use of one or more detectors configured for detecting one or more undesired impurities (e.g., water) to make sure the trailer hydrogen gas did not have such impurities and/or a content of such impurities that met or exceeded a pre-selected impurity threshold.

Embodiments of the apparatus 1 can be configured to perform exemplary embodiments of a process for utilization of hydrogen gas output from at least one trailer 11. FIG. 2 illustrates an embodiment of such a process that includes optional step S3 as well as steps S1 and S2. It should be appreciated that other embodiments of the process can also use other steps or less steps (e.g., may not use step S3, may use additional steps with or without step S3, etc.).

As can be appreciated from the above, in a first step S1, hydrogen gas from within the trailer(s) 11 can be output from the trailer(s) 11 (e.g., via at least one a trailer hydrogen gas output conduit 11v). The output hydrogen gas can be hydrogen gas that is formed from a first portion of the liquid hydrogen within the trailer(s) 11 vaporizing into a gas while the trailer(s) are being filled with liquid hydrogen and/or storing the liquid hydrogen prior to the trailers being transported off-site. The vaporized first portion of the liquid hydrogen that is output from the trailer(s) 11 can be relatively small portion of the liquid hydrogen within the trailer(s) 11 or fed to the trailer(s) for storage therein (e.g., between greater than 0% to less than 15% of the liquid hydrogen fed to the trailer(s) 11 vaporizing into a gas, etc.). A second portion of the liquified hydrogen fed to the trailer(s) 11 for storage and subsequent transport can remain a liquid and stay within the trailer(s) 11. This second portion can be between greater than or equal to 85% and less than 100% of the liquid hydrogen fed to the trailer(s) 11 for storage therein.

In a second step S2, the trailer hydrogen gas output from the trailer(s) 11 can be sent to (a) a compression system 5, (b) a liquefaction unit 9 for liquefaction, (c) a storage unit of hydrogen storage 7, (d) a pipeline 13 for injection therein, (e) a turbine 15 for use in electricity generation, and/or (f) a fuel cell 17 for use as a fuel source for backup power for a plant or facility that can be provided by the fuel cell 17. This sending of the hydrogen gas output from the trailer(s) 11 can be considered feeding of hydrogen gas from the trailer(s) 11 to the compression system 5, liquefaction unit 9, storage unit of hydrogen storage 7, the pipeline 13, the turbine 15, and/or the fuel cell 17.

In some embodiments, the sending of the hydrogen gas from the trailer(s) 11 to (a) the compression system 5, (b) the liquefaction unit 9 for liquefaction, (c) the storage unit of hydrogen storage 7, (d) the pipeline 13 for injection therein, (e) the turbine 15 for use in electricity generation, and/or (f) the fuel cell 17 can be performed in response to determining that an availability of renewable power for production of hydrogen is at or below a pre-selected threshold. For example, the sending of the hydrogen gas from the trailer(s) 11 can be performed at night when renewable power via solar power that can be utilized for hydrogen production may be non-existent or very low. This type of processing can help with load management for the liquefaction unit 9 and/or provide improved operational efficiency or flexibility.

The sending of the hydrogen gas from the trailer(s) 11 that can occur at night or during a low renewable power availability occurrence can be performed in conjunction with determining when to load the trailer(s) 11 with liquid hydrogen from the liquefaction unit 9. For instance, in some embodiments, the loading of the trailer(s) 11 via feeding of liquid hydrogen from the liquefaction unit 9 can be performed at night or a time when the availability of renewable power for production of hydrogen is determined to be at or below a pre-selected threshold. The sending of the hydrogen gas from the trailer(s) 11 that can occur as a result of the loading of the trailer(s) 11 and/or the trailer(s) storing the liquid hydrogen can also occur at about this same time or during the same low renewable power occurrence.

In a third optional step S3, the flow of hydrogen fluid (e.g., hydrogen gas) being fed to liquefaction unit 9 (e.g. compressed hydrogen gas output from the compression system 5 for feeding to the liquefaction unit 9) can be cooled with the trailer hydrogen output from the trailer(s) 11 before that trailer hydrogen is fed to the compression system 5, hydrogen storage 7, pipeline 13, turbine 15, and/or at least one fuel cell 17. For example, the trailer hydrogen can be fed to the first heat exchanger HX1 as a cooling medium for cooling the compressed hydrogen gas output from the compression system 5 at the pre-selected compression system output pressure. The cooling provided by the trailer hydrogen can facilitate cooling of the compressed hydrogen to the pre-selected liquefaction unit feed temperature for feeding to the liquefaction unit 9 via the liquefaction feed conduit 9a for liquifying the hydrogen, for example. The warmed trailer hydrogen gas output from the first heat exchanger HX1 can then be fed to the compression system 5, hydrogen storage 7, the pipeline 13, at least one fuel cell 17, and/or the turbine 15, as discussed above, for example.

As noted above, in some implementations of the process, the composition of the trailer hydrogen gas can be analyzed before it is sent back to the compression system 5 and/or hydrogen storage 7 so that the hydrogen gas stream can be analyzed to verify that the hydrogen gas may not have impurities or other elements that could possibly contaminate the hydrogen liquefaction processing or cause other unexpected issues. Such an analysis can also be performed before the hydrogen gas is fed to the fuel cell 17, turbine 15 or pipeline 13 in some embodiments. The compositional analysis can be performed by a composition analyzer, sample extraction or other composition detection and analysis scheme. The compositional analysis can also, or alternatively, be performed by use of one or more detectors configured for detecting one or more undesired impurities (e.g., water) to make sure the trailer hydrogen gas did not have such impurities and/or a content of such impurities that met or exceeded a pre-selected impurity threshold.

It should be appreciated embodiments of the process can also use other steps. For example, the process can also include installing an embodiment of the apparatus 1 at a plant to facilitate reliquefying hydrogen gas output from at least one trailer 11 or otherwise utilizing that hydrogen gas output from at least one trailer 11. It should be appreciated that such a step can be performed such that an embodiment of the apparatus 1 can be retrofit into a pre-existing plant so the plant can have the apparatus 1 added into it. The step can also be performed so that the apparatus 1 is included in a new plant that is to be constructed.

It should be appreciated that modifications to the embodiments explicitly shown and discussed herein can be made to meet a particular set of design objectives or a particular set of design criteria. For instance, the arrangement of valves, piping, and other conduit elements (e.g., conduit connection mechanisms, tubing, seals, valves, etc.) for interconnecting different units of the apparatus for fluid communication of the flows of fluid between different elements (e.g., heat exchangers, storage devices, compressors, etc.) can be arranged to meet a particular plant or apparatus 1 layout design that accounts for available area of the plant, sized equipment of the plant, and other design considerations. As another example, the flow rate, pressure, and temperature of the fluid passed through the various apparatus or system elements can vary to account for different design configurations and other design criteria.

Embodiments of the apparatus for utilization of hydrogen gas output from at least one trailer, process for utilization of hydrogen gas output from at least one trailer, and/or system for utilization of hydrogen gas output from at least one trailer can each be configured to include process control elements positioned and configured to monitor and control operations (e.g., temperature and pressure sensors, flow sensors, an automated process control system having at least one work station that includes a processor, non-transitory memory and at least one transceiver for communications with the sensor elements, valves, and controllers for providing a user interface for an automated process control system that may be run at the work station and/or another computer device of the plant, etc.). It should be appreciated that embodiments can utilize a distributed control system (DCS) for implementation of one or more processes and/or controlling operations of an apparatus 1 as well.

As another example, it is contemplated that a particular feature described, either individually or as part of an embodiment, can be combined with other individually described features, or parts of other embodiments. The elements and acts of the various embodiments described herein can therefore be combined to provide further embodiments. Thus, while certain exemplary embodiments of the process, apparatus, system and methods of making and using the same have been shown and described above, it is to be distinctly understood that the invention is not limited thereto but may be otherwise variously embodied and practiced within the scope of the following claims.

1. An apparatus for utilization of hydrogen gas output from at least one trailer comprising:
at least one trailer positioned to receive liquified hydrogen and store the liquified hydrogen therein such that a portion of the liquid hydrogen vaporizes into hydrogen gas while the liquified hydrogen is stored in the trailer; and
a heat exchanger positioned between the liquefaction unit and the at least one trailer to cool a feed of hydrogen output from the compression system via the hydrogen gas output from the at least one trailer before the hydrogen output from the compression system is fed to the liquefaction unit, the hydrogen gas output from the at least one trailer fed to the heat exchanger being output from the heat exchanger as a warmed flow of hydrogen gas,
the at least one trailer connectable to a turbine, a pipeline, a fuel cell, a storage unit, a liquefaction unit and/or a compression system for feeding hydrogen gas formed within the trailer storing the liquified hydrogen to the liquefaction unit, the compression system, the fuel cell, the storage unit, the turbine and/or the pipeline.

2. (canceled)

3. The apparatus of claim 1, comprising the turbine, wherein the heat exchanger is positioned so that the warmed flow of hydrogen gas output from the heat exchanger is feedable to the turbine.

4. The apparatus of claim 1, wherein the heat exchanger is positioned so that the warmed flow of hydrogen gas output from the heat exchanger is injectable into the pipeline.

5. The apparatus of claim 4, wherein the pipeline is a natural gas pipeline and the warmed flow of hydrogen gas output from the heat exchanger is injectable into the pipeline to reduce a carbon intensity of fluid within the pipeline.

6. The apparatus of claim 1, wherein the at least one trailer is connectable to the liquefaction unit for feeding the hydrogen gas formed within the trailer storing the liquified hydrogen to the liquefaction unit.

7. The apparatus of claim 1, wherein the at least one trailer is connectable to the compression system for feeding the hydrogen gas formed within the trailer storing the liquified hydrogen to the compression system for undergoing compression before being fed to the liquefaction unit.

8. The apparatus of claim 1, wherein the liquefaction unit comprises at least one liquefier.

9. The apparatus of claim 1, wherein the compression system comprises a first compressor.

10. The apparatus of claim 9, wherein the compression system is connected to the liquefaction unit to feed compressed fluid comprising hydrogen gas to the liquefaction unit.

11. The apparatus of claim 1, wherein the at least one trailer is connectable to the turbine, the pipeline, the fuel cell, the storage unit, the liquefaction unit and/or the compression system such that a first portion of the liquid hydrogen that is greater than 0% and less than 15% of the liquid hydrogen fed to the at least one trailer for storage therein is vaporized and subsequently fed as the hydrogen gas formed within the trailer storing the liquified hydrogen to the liquefaction unit, the compression system, the fuel cell, the storage unit, the turbine and/or the pipeline and a second portion of the liquid hydrogen that is less than or equal to 85% and less than 100% of the liquid hydrogen fed to the at least one trailer is retained and stored in the at least one trailer.

12. A process for utilization of hydrogen gas output from at least one trailer comprising:
forming hydrogen gas from liquid hydrogen stored within at least one trailer;
feeding the hydrogen gas from the at least one trailer to a pipeline, a storage unit, a fuel cell, a turbine, a liquefaction unit for subsequent liquefaction of the hydrogen gas and/or a compression system for compression of the hydrogen gas for subsequent liquefaction of compressed hydrogen gas output from the compression system via a liquefaction unit connected to the compression system ;
feeding the hydrogen gas from the at least one trailer to a heat exchanger positioned between the compression system and the liquefaction unit to cool a feed of compressed hydrogen gas output from the compression system via the hydrogen gas output from the at least one trailer before the compressed hydrogen gas output from the compression system is fed to the liquefaction unit, and
the heat exchanger outputting the hydrogen gas received from the at least one trailer as a warmed flow of hydrogen gas for feeing to the pipeline, the fuel cell, the storage unit, the turbine or the compression system.

13. (canceled)

14. The process of claim 12, comprising:
feeding the warmed flow of hydrogen gas output from the heat exchanger to the turbine.

15. The process of claim 12, comprising:
feeding the warmed flow of hydrogen gas output from the heat exchanger to the pipeline.

16. The process of claim 15, wherein the pipeline is a natural gas pipeline and the warmed flow of hydrogen gas output from the heat exchanger is injectable into the pipeline to reduce a carbon intensity of fluid within the pipeline.

17. The process of claim 12, wherein the feeding of the hydrogen gas from the at least one trailer to the pipeline, the fuel cell, the storage unit, the turbine, the liquefaction unit for subsequent liquefaction of the hydrogen gas and/or the compression system for compression of the hydrogen gas for subsequent liquefaction of compressed hydrogen gas output from the compression system via the liquefaction unit connected to the compression system comprises:
feeding the hydrogen gas formed within the at least one trailer storing the liquified hydrogen to the compression system for undergoing compression before being fed to the liquefaction unit.

18. The process of claim 17, wherein the compression system comprises a first compressor and at least one second compressor connected to the first compressor.

19. The process of claim 12, wherein the feeding of the hydrogen gas from the at least one trailer to the pipeline, the fuel cell, the storage unit, the turbine, the liquefaction unit for subsequent liquefaction of the hydrogen gas and/or the compression system for compression of the hydrogen gas for subsequent liquefaction of compressed hydrogen gas output from the compression system via the liquefaction unit connected to the compression system comprises:
feeding the hydrogen gas from the at least one trailer to the liquefaction unit for liquefaction of the hydrogen gas.

20. The process of claim 18, wherein the liquefaction unit comprises a first liquefier and at least one second liquefier and the hydrogen gas from the at least one trailer is fed only to the first liquefier for liquefaction.

21. The process of claim 12, wherein the forming of the hydrogen gas from liquid hydrogen stored within the at least one trailer occurs such that a first portion of the liquid hydrogen that is greater than 0% and less than 15% of the liquid hydrogen fed to the at least one trailer for storage therein is vaporized and subsequently fed as the hydrogen gas formed within the trailer storing the liquified hydrogen to the liquefaction unit, the compression system, the fuel cell, the storage unit, the turbine and/or the pipeline and a second portion of the liquid hydrogen that is less than or equal to 85% and less than 100% of the liquid hydrogen fed to the at least one trailer is retained and stored in the at least one trailer.

22. (canceled)

23. The process of claim 12, wherein the feeding of the hydrogen gas from the at least one trailer is performed in response to determining that an availability of renewable power for production of hydrogen is at or below a pre-selected threshold.
